(19) United States
(12) Patent Application Publication
(10) Pub. No.: US 2006/0115263 A1
(43) Pub. Date: Jun. 1, 2006

(54) Device and method for unloading film

(75) Inventors: Anthony DiRisio, Rochester, NY (US); Robert S. Jones, Rochester, NY (US); Thomas W. Mort, Rochester, NY (US); Joel S. Lawther, East Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/999,018

(22) Filed: Nov. 29, 2004

(51) Int. Cl. G03B 1/00

(52) U.S. Cl. 396/388

(57) ABSTRACT

A device and method for unloading a single-use camera utilizes pivotable housing with a cavity. The cavity receives a typical camera comprising film, a take-up cartridge, a lens, and a metering mechanism. One or more clamps with a de-metering protrusion deactivate the metering mechanism in the camera. An actuator moves the clamps to engage and release the camera. The pivotable housing containing the camera is rotated and a gear winds the film into a take-up cartridge. A hook mechanism with a hook driven by a second gear and motor opens the single-use camera so that a cartridge extractor can remove the take-up cartridge with rewound film from the camera. A transfer device moves the take-up cartridge with film from the camera to an operator selected position.

### FIELD OF THE INVENTION

The present embodiments relate generally to the field of photography, and in particular to developing film from single-use cameras. More specifically, the present embodiments relate to a device and method for unloading film from a single-use camera.

### BACKGROUND OF THE INVENTION

Single-use or one-time-use cameras that contain film and a camera all-in-one housing have become well known and widely used. The one-time-use camera is a simple point-and-shoot type comprising an opaque plastic main body part that supports a conventional film cartridge in a cartridge receiving chamber, an unexposed film roll pre-wound from the film cartridge onto a film supply spool in a film supply chamber, a fixed-focus taking lens, a film metering mechanism with a rotatably supported metering sprocket that engages the filmstrip, a manually rotatable film winding thumbwheel rotatably engaged with a film take-up spool inside the film cartridge, a single-blade shutter, a manually depressible shutter release button, a rotatable frame counter for indicating the number of exposures remaining to be made on the filmstrip, a direct see-through viewfinder having front and rear viewfinder lenses, and in some models an electronic flash. A pair of opaque plastic front and rear cover parts houses the main body part between them to complete the camera unit. The rear cover part connects to the main body part and/or to the front cover part to make the main body part light-tight. A decorative cardboard outer box or label at least partially covers the camera unit and has respective openings for the taking lens, thumb wheel, and other features.

After each picture is taken with the one-time-use camera, the photographer typically manually rotates the thumbwheel in a film winding direction to similarly rotate the film take-up spool inside the film cartridge. This winds an exposed frame of the filmstrip into the film cartridge. The rewinding movement of the filmstrip rotates the metering sprocket in engagement with the filmstrip to decrement the frame counter to its next lower-numbered setting and to pivot a metering lever into engagement with the thumbwheel in order to prevent further manual rotation of the thumbwheel. Manually depressing the shutter release button to take another picture pivots the metering lever out of engagement with the thumbwheel to permit renewed rotation of the thumbwheel. When the maximum number of exposures available on the filmstrip have been made, and the filmstrip is completely wound into the film cartridge, the one-time-use camera is given to a photofinisher who manually tears the outer box off the camera unit, manually separates the rear cover part from the main body part, and removes the film cartridge with the exposed filmstrip from the cartridge receiving chamber. Then, he removes the exposed filmstrip from the film cartridge to develop the latent images and make prints for the customer. At least some of the used camera parts are recycled or reused to re-manufacture the camera.

Prior art U.S. Pat. No. 5,596,385 discloses a method of opening a one-time-use camera to obtain the film cartridge with the exposed filmstrip. According to the method, a knife cuts away corresponding bottom portions of the front and rear cover parts and the main body part to make a bottom access opening to the cartridge receiving chamber. Then, the film cartridge is removed from the cartridge receiving chamber through the opening. The main body part is relatively expensive to manufacture as compared to the front and rear cover parts and, therefore, is preferred to be recycled. However, since the knife cuts the bottom portion of the main body part off when the bottom portions of the front and rear cover parts are cut off, it is not practical to attempt to recycle the main body part.

A need exists for a method and device to unload single-use camera. The needed method and device enable more complete recycling of all parts of the single-use camera. A need exists for an automated device to unload a single-use camera.

The present embodiments described herein were designed to meet these needs.

### SUMMARY OF THE INVENTION

Embodied herein is a device for unloading a single-use camera having a housing, film, a film supply spool, a film take-up cartridge, a lens, a shutter, and a metering mechanism. The device utilizes a pivotable housing with a cavity that receives the camera. One or more clamps driven by an actuator are used to engage and release the single-use camera as needed. A de-metering protrusion disposed on one of the clamps is used to de-activate the metering mechanism in the single-use camera. Once the single-use camera is held in place by the clamps, the pivotable housing rotates and a gear and motor wind the film in the single-use camera into a take-up cartridge. A hook mechanism with a hook driven by a second gear and motor opens the single-use camera to allow a cartridge extractor to remove the take-up cartridge with rewound film from the single-use camera. A transfer device moves the take-up cartridge with rewound film from the camera to an operator selected position.

A method for using the device to unload a single-use camera is embodied herein.

### BRIEF DESCRIPTION OF THE DRAWINGS

In the detailed description of the preferred embodiments presented below, reference is made to the accompanying drawings, in which:

FIG. 1 is a diagram of a film processing system in accordance with an embodiment.

FIG. 2 depicts an internal view of an embodiment of the device for unloading a single-use camera.

FIG. 3 depicts a side view of the interior of a typical single-use camera.

FIG. 4 depicts a perspective view of a camera in a clamped state.

FIG. 5 depicts a perspective view of an embodiment of the hook linkage.

FIG. 6 depicts a perspective view of an embodied device showing where the film magazine exits.

FIG. 7 depicts a pictorial series of an embodiment of a tongue extraction method.

FIG. 8 depicts a perspective view of an embodied device as a kiosk.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

The present embodiments are designed to unload film from a single-use camera or a film cartridge. The embodied devices are easier for a consumer to use and increase the versatility of a self-service kiosk to handle film with only one interface. The devices, when used in a film processing station, streamline the typical steps of opening and removing film from a camera to one simple step. The film in the camera is processed through a digital film development system as described herein.

In operation, exposed film or partially exposed film from single-use camera or exposed film from a film cartridge needs to be removed from the housing in order to develop the film. In a preferred embodiment, the camera and associated film need to be transported through a self-service customer operated kiosk that contains a development system. The development system applies a processing solution to the film that develops the film. A transport system moves the film from the processing unit to a scanning unit. A scanning unit scans the film using light with one or more portions of visible light of the electromagnetic spectrum. Light from the film is measured by a sensor system that, in turn, produces sensor data. The sensor data represents the dyes, images, and silver associated with the film at each pixel. The sensor data is communicated to a data processing system that processes the sensor data using image processing software. The image processing software produces a digital image from the sensor data. The data processing system can operate to enhance or otherwise modify the digital image. The data processing system communicates the digital image to an output device for viewing, storing, printing, communicating or any combinations thereof.

In other embodiments, the improved digital film development system with the film unloading device can be used for commercial film lab processing applications. The device enables more parts of a single-use camera to be recycled by providing a systematic automatic unloading device that ultimately reduces the environmental impact from the use of single-use cameras. The improved digital film system using the device described herein can be adapted to any suitable application without departing from the scope and spirit of the embodiments.

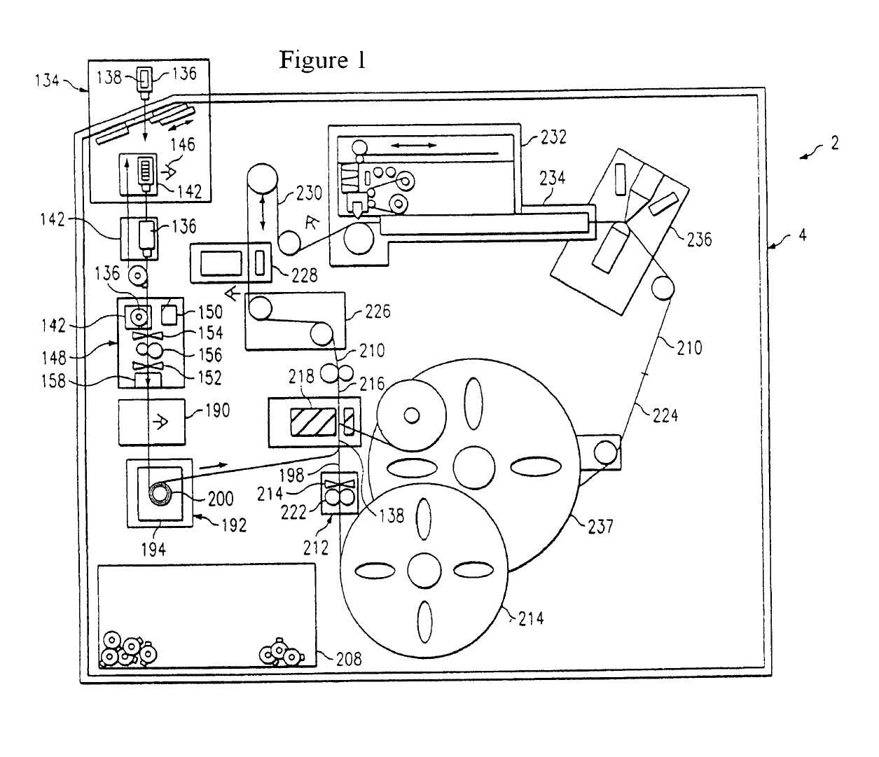

With reference to the figures, FIG. 1 is a diagram of a film processing system in accordance with an embodiment. The embodied film processing system 2 is capable of providing film developing for a self-service film processing system or for commercial film lab processing applications and the like.

The system includes a light tight enclosure 4 that houses numerous process stations. Each one of the process stations is capable of carrying out one or more operations associated with developing a film provided in a roll format, such as from a single-use camera or film cartridge. The process stations define a process path of the film processing system. Each one of the film processing stations is advantageously positioned and constructed to minimize a respective occupied volume of space. In this manner, the overall size of the enclosure 4 can be minimized to reduce space requirements. The embodied film unloading device makes the dimensions of a self-service kiosk around 20% smaller than those previously designed. The smaller footprint of the self-service kiosk enables the kiosk to be installed in small, premium, rent spaces that were not previously possible.

When a film processing system 2 unloads a film cartridge, the system starts with a data acquisition device 146 capable of acquiring film attribute data from the film cartridge. If the film processing system 2 is for unloading and developing film from a single-use camera, the camera is first unloaded with the embodied film unloading device described below. The attribute data is then read from the unloaded film. Alternatively, the attribute data can be retrieved from the camera at the film unloading device.

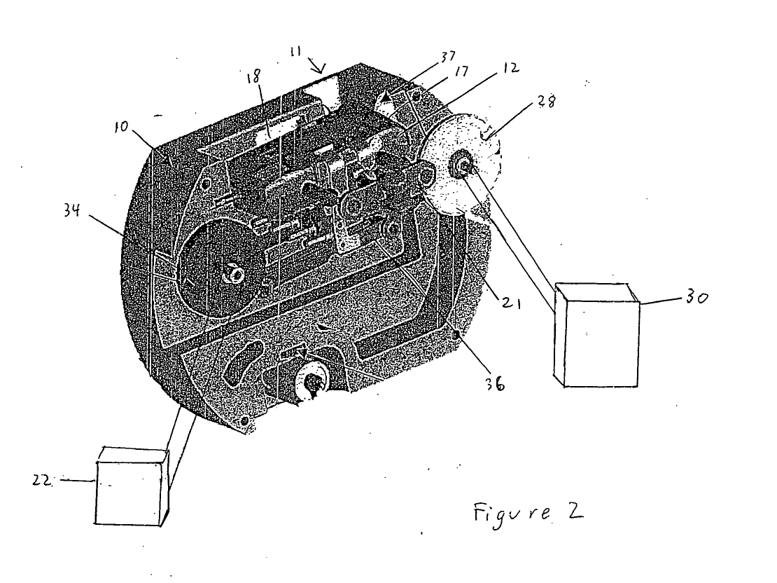

FIG. 2 depicts an internal view of a device for unloading a single-use camera 12. A pivotable housing 10 for the device, depicted in a cross-section, can be composed of a polymer, a plastic, a metal, a coated metal, or combinations thereof. The pivotable housing 10 can include a centrally located pivot adapted to rotate the pivotable housing 10 up to 360 degrees.

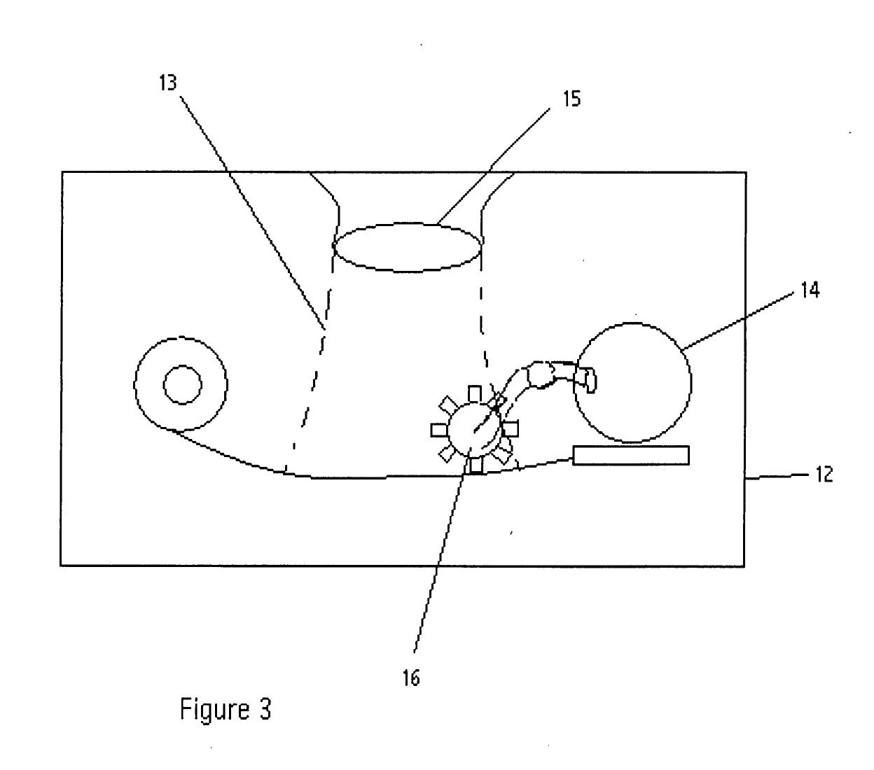

A cavity 11 in the housing 10 is used to receive a single-use camera 12. A typical single-use camera 12 includes film 138, a take-up cartridge 14, a lens 15, a light from lens 13 and a metering mechanism 16. A shutter (not shown) is used in the typical camera. A side view of the interior of a typical single-use camera is depicted in FIG. 3. The metering mechanism 16 prevents film 138 from advancing between successive images. The metering mechanism 16 can utilize a locking thumbwheel used to advance the film manually or with a gear. The metering mechanism 16 can include a counter to notify the user how much of the film has been used.

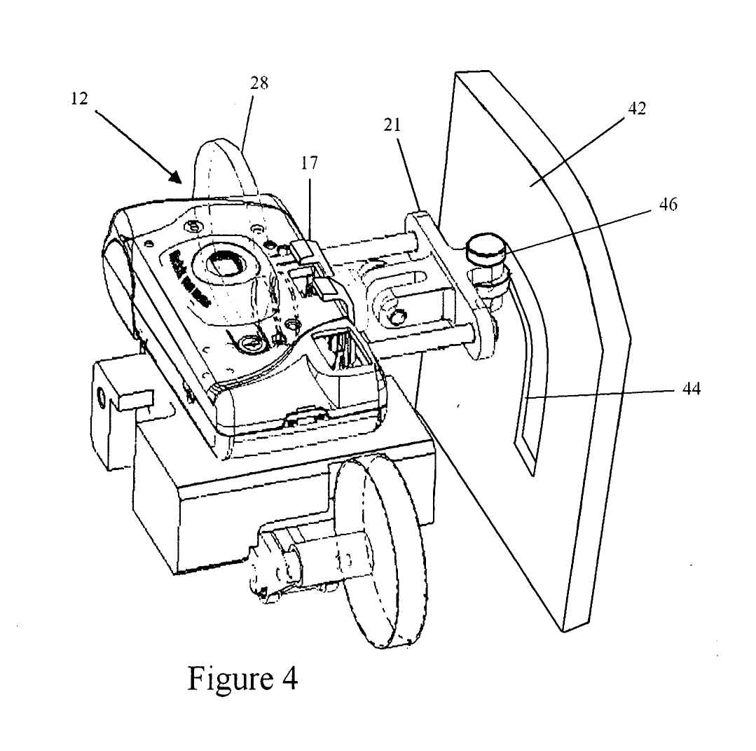

A device for unloading a single-use camera can include clamps 17 and 18. One of the clamps 17 can include a de-metering protrusion used to deactivate the metering mechanism 16 in the single-use camera 12. FIG. 4 depicts a perspective view of the camera 12 in the clamped state.

Returning to FIG. 2, an actuator 21 in the device affects the clamps 17 and 18 by setting the clamps 17 and 18 in motion to hold (seat) and release the single-use camera 12. The actuator 21 can include a rib 44 disposed on a frame 42 and numerous rollers 46 to engage the rib 44 in order to open and close the clamps 17 and 18, as depicted in FIG. 4. The pivotable housing 10 rotates around the frame 42. Only one roller is depicted in FIG. 4, but the device can include more than one roller as needed to open and close the clamps 17 and 18. The clamps 17 and 18 can be spring loaded to assist in pushing against the camera body during clamping

The device can include numerous motors to assist in moving the various elements of the device. A first motor 22 is used to pivot the pivotable housing 10 from a first position to a second position. The distance from the first position to the second position can range from about 10 degrees to about 90 degrees. Preferably, the distance between the first position and the second position is 43 degrees. A second motor 30 is used to move a gear 28 that winds the film from the single-use camera 12 into the take-up cartridge 14.

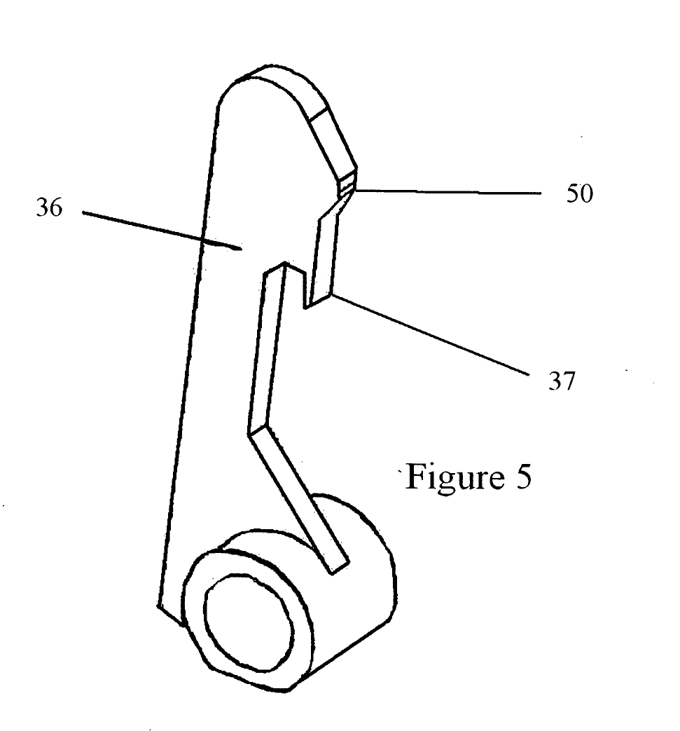

The device includes a hook mechanism 36 with a hook 37. FIG. 5 depicts an embodiment of the hook mechanism 36. The hook mechanism 36 is used to pry open the single-use camera 12. The hook 37 can include a cam feature 50 that is used to push and open the single-use camera 12. The cam feature 50 allows the hook 37 to unlatch the access door of the camera before the actual opening of the camera. The hook mechanism 36 can be spring loaded. The hook mechanism 36 is driven by a second gear 34 and second motor 30. The second gear 34 and the second motor 30 are shown in FIG. 2.

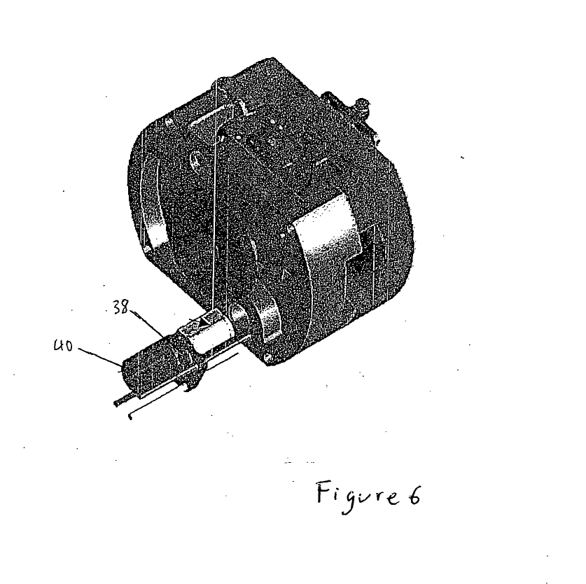

The device includes a cartridge extractor 38 and a transfer device 40 as depicted in FIG. 6. The cartridge extractor 38 is used to remove the take-up cartridge 14 with rewound film from the single-use camera 12. The transfer device 40 is used to move the take-up cartridge 14 with film from the single-use camera 12 to an operator selected position.

Returning to FIG. 1, in an embodiment of the data acquisition device 146, a bar code reader is used to read a bar code on the take-up cartridge 14 or on the camera 12. The information included on the bar code can include film or camera attribute data, such as film speed, number of exposures, date of manufacture of the film, film processing data, film manufacturer, and the like. If the film attribute date of the film 138 does not match that of expected data (for example, the film is of an unknown manufacturer or has unknown film processing data), the cartridge or camera can be returned to the user. As discussed below in greater detail, the film attribute data is useful and/or necessary for several of the operations performed by the film processing system 2. Once read, the camera or cartridge is forwarded to the film unloading device.

After the film unloading device removes film from the camera, the film is placed in a magazine carriage 142 that includes a magazine receiver that facilitates holding the film during operations at the film magazine loading station 134. The magazine carriage 142 assists in transporting the film to a tongue preparation station 148. The magazine carriage 142 also assists in holding the film during operations at the tongue preparation station 148. The tongue preparation station 148 is one example of a film preparation station. A film magazine transport apparatus can be implemented for transporting the magazine carriage 142 to the tongue preparation station 148. A linear transport device and a rotation transport device are examples of the film magazine transport apparatus.

The tongue preparation station 148 includes a tongue extraction device 150, a first film cutting device 152, a second film cutting device 154, driven feed rollers 156 and a film diverter 158. The tongue extraction device 150 is capable of extracting a tongue of film 138 from the film. The first film cutting device 152 and the second film cutting device 154 are capable of cutting a tongue and a tail, respectively, of film. A combination film cutting device (not shown) is capable of cutting both the tongue and the tail of the film and may replace the first film cutting device 152 and the second film cutting device 154.

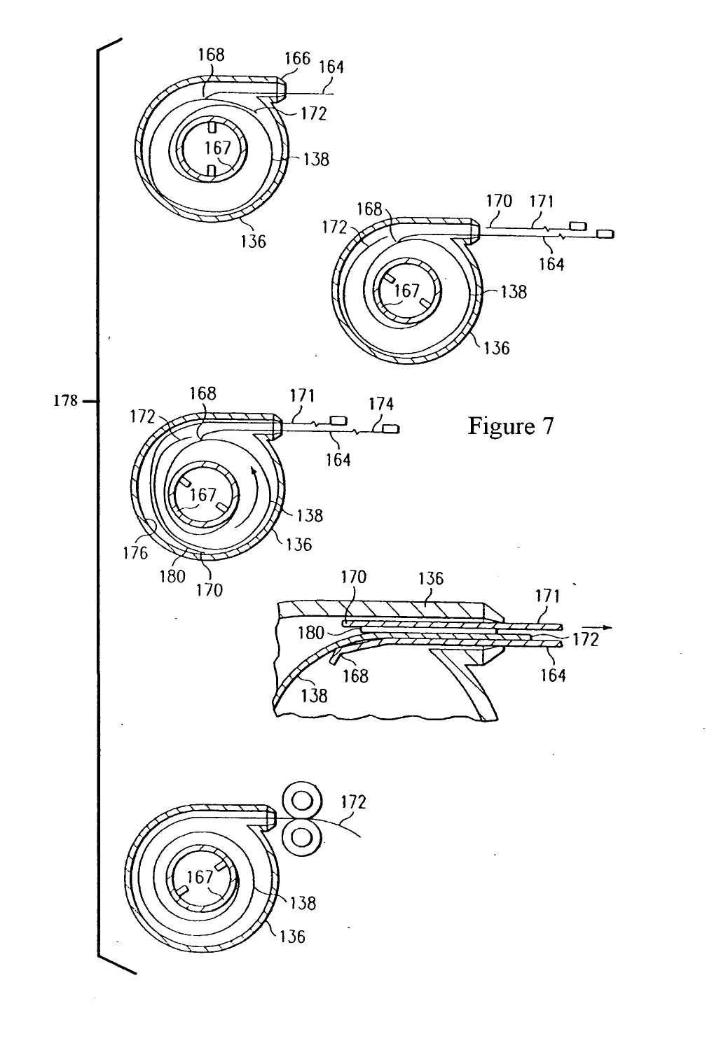

An embodiment of a tongue extraction method 178 is depicted in FIG. 7. A tongue stripper 164 is inserted through a light-tight film window 166 to the film. The tongue stripper 164 is configured such that a leading end 168 of the tongue stripper 164 is canted toward a spindle 167 and into engagement with the film. In this manner, the leading end 168 of the tongue stripper 164 is in preloaded engagement with the film.

After inserting the tongue stripper 164, the step of enabling synchronous insertion of a leading end 170 of a tongue extractor 171 relative to the tongue 172 of the film is performed. Enabling synchronous insertion is defined herein to mean that the leading end 170 of the tongue extractor 171 is inserted into a film magazine 136 holding the film at an essentially common velocity as a rotational velocity of the tongue 172 of the film and at a prescribed relationship to the tongue 172 is increased relative to conventional tongue extraction techniques.

One embodiment for enabling synchronous insertion of the tongue extractor 171 includes rotating the film at a known and constant speed in a film rewind direction. In response to rotating the film in the rewind direction, the film is wrapped into a relatively tightly formed coil around the spindle 167 of the film magazine 136. As the tongue 172 of the film travels past the leading end 168 of the tongue stripper 164, a ‘tick’ is produced as the leading end 168 of the tongue stripper 168 as the tongue stripper 168 re-engages the film 138. A sequence of such ticks is an example of tongue extractor synchronizing data.

An acoustic, a mechanical or an otherwise suitable device may be used for monitoring such ticks. One embodiment of monitoring the acoustic tick includes associating the acoustic tick with an angular position of the spindle 167, such as via an angular encoder.

After monitoring the acoustic tick for one or more revolutions of the film 138, the step of determining insertion synchronization parameters for the tongue extractor 171 is performed. The objective of the synchronization parameters is to enable the tongue extractor 171 to be inserted into the film magazine 136 with minimal relative movement between the tongue extractor 171 and points of contact with the film 138 and with the leading end 170 of the tongue extractor 171 maintained at a desired position relative to the tongue 172 of the film 138. One example of determining insertion synchronization parameters includes determining an insertion synchronizing spindle speed and a tongue extractor insertion dwell. The insertion synchronizing spindle speed is a speed at which the spindle 167 is rotated for minimizing, and preferably eliminating, relative movement between the tongue extractor 171 and points of contact with the film 138 as the tongue extractor is being inserted into the film magazine 136. The tongue extractor insertion dwell is a time delay, incremental spindle rotation, or other suitable dwell parameter that synchronizes initiation of a tongue extractor insertion operation with respect to the angular position of the spindle 167. Alternatively, initiation of the tongue insertion operation could be based on a correlation between the acoustic tick patterns (for example, time between ticks) and tongue extractor insertion dwell.

After the tongue extractor synchronization parameters are determined, the step of implementing the tongue extraction synchronization parameters is performed. Examples of implementing the tongue extraction synchronization parameters includes rotating the magazine spindle 167 at the synchronizing spindle velocity and verifying that the tongue extractor is at a prescribed position.

After enabling synchronous insertion of the tongue extractor 171, the tongue extractor 171 is inserting into the film magazine 136 through the light-tight film window 166 of the film magazine 136. The tongue extractor 171 is positioned adjacent to an outside face 174 of the tongue stripper 164. Accordingly, the tongue extractor 171 follows an interior surface 176 of the film magazine 136 as the tongue extractor 171 is inserted into the film magazine 136.

One embodiment of inserting the tongue extractor 171 into the film magazine 136 includes synchronously decelerating the spindle 167 and the tongue extractor 171 for achieving respective stopped positions. In this manner, relative movement between the tongue extractor 171 and points of contact with the film 138 is minimized or preferably eliminated. The stopped position of the tongue extractor 171 is at least partially defined by a prescribed insertion distance of the tongue extractor 171.

After inserting the tongue extractor 171 into the film magazine 136, the tongue extractor 171 is withdrawn from the film magazine 136. One embodiment for withdrawing the tongue extractor 171 from the film magazine 136 includes synchronously accelerating the spindle 167 in a direction opposite the rewind direction and accelerating the tongue extractor in a withdrawal direction. In this manner, relative movement between the tongue extractor 171 and points of contact with the film 138 is minimized or preferably eliminated. As the tongue extractor 171 is withdrawn from the film magazine 136, the tongue film 172 is drawn over the film stripper 164 and is carried out of the light-tight film window 166. Another embodiment for withdrawing the tongue extractor 171 into the film magazine 136 includes allowing the film 138 to free-wheel while the tongue extractor 171 is being withdrawn.

The tongue extractor 171 includes a friction pad 180, as depicted in FIG. 7, attached to the tongue extractor 171. The friction pad 180 is positioned such that the pad is capable of engaging a surface of the film 138. Furthermore, the tongue extractor 171 and the film stripper 164 are configured for exerting a nominal clamping force on the tongue film 172. Accordingly, the friction pad 180 remains engaged on a mating surface of the film 138 as the tongue extractor 171 is withdrawn from the film magazine 136.

In response to withdrawing the tongue extractor 171 from the film magazine 136, a determination is made whether the tongue film 172 of the film 138 was successfully withdrawn form the film magazine 136. In response to the tongue film 172 of the film 138 being successfully withdrawn, the tongue stripper 164 is removed from the film magazine 136. In response to the tongue film 172 of the film 138 not being successfully withdrawn, the step for enabling synchronous insertion of a leading edge 170 of a tongue extractor 171 relative to the tongue film 172 of the film 138 is repeated.

Referring back to FIG. 1, the tongue of the film 138 is extracted in a manner in which the tongue is positioned between the driven feed rollers 156. In this manner, driven feed rollers 156 are capable of pulling the film 138 from the film magazine 136. As the film 138 is being pulled from the film magazine 136, the tongue (for example, the leading end) of the film 138 is routed through a film diverter 158.

The film diverter is capable of being moved between three positions. The film divert 158 is movable to a tongue trimming position for enabling the tongue of the film to be trimmed by the first film cutting device 152. The film divert 158 is movable to a film reverser position for enabling the film to be routed through a film inspection station 190 and to a film reversing station 192. The film diverter 158 is movable to a bypass position for routing the film 138 to a splicing station.

The film inspection station 190 is capable of detecting imperfections and defects in the film 138. Examples of imperfections and defects include scratches, tears, cuts, missing perforations and the like. If the film 138 is found to have significant imperfections of defects, the film 138 can be rewound into the film magazine 136. A CMOS linear array in conjunction with low angle lighting on a surface of the film 138 is an example of an arrangement for detecting surface scratches, cuts and tears. A photo diode aligned with an LED is an example of an arrangement for detecting missing perforations. In an instance where the film 138 is found to be unsuitable for processing in the film processing system 2, the film processing system 2 is capable of rewinding the film 138 in the magazine 136 and facilitating disposition of the film 138. Examples of facilitating disposition of the film 138 include returning the film magazine 136 to a corresponding user, directing the film magazine 136 to a storage bin and returning the film magazine 136 to a corresponding magazine delivery system.

The film 138 passes through the inspection station 190 and is received in a film reverser 194 at the film reversing station 192. The film reverser 194 facilitates reversing the orientation of the film 138 such that a tail end of the film 138 becomes a leading end of the film 138. Accordingly, the orientation of the film 138 is reversed as the film 138 continues from the reversing station 192 through the remaining stations of the film processing system 2.

The tail end (leading end) of the film 138 was originally attached to a spindle of the film magazine 136. Accordingly, the tail end (leading end) of the film 138 is unexposed. As discussed below in greater detail, reversing the direction of the film 138 is advantageous such that the calibration exposure is positioned at the leading end of the film 138.

The film reverser 194 includes a body, a spindle 198 mounted in a cavity 200 of the body, and a door for covering a film passage. The spindle 198 is rotatably mounted on the body for being rotated about a longitudinal axis of the cavity 200. The spindle 198 includes a shaft 206 for enabling the spindle 198 to be rotated by a suitable drive device (for example, an electric motor). The film passage extends from an exterior surface of the body to the cavity 200. The door is movable, such as by a solenoid, between an open position O and a closed position C with respect to the film passage. When in the closed position C, light is effectively precluded from entering the body through the film passage.

The tongue of the film 138 is fed, such as by the driven feed rollers 156, into the cavity 200 through the film passage. The film 138 makes an initial wrap around the spindle 198. The spindle 198 is being rotated as the film 138 is being fed into the cavity 200. In one embodiment of rotating the spindle 198, the spindle 198 is rotated at a speed providing a higher spindle surface velocity that the velocity at which the film 138 is being fed into the reverser 194. Accordingly, the speed differential between the spindle 194 and the film 138 acts to wind the film 138 into a relatively tight roll against the spindle 198.

Continuing with FIG. 1, as the driven feed rollers 156 pull the film 138 from the film magazine 136 and the film is fed into the reverser 194, a total length of the film 138 that has been pulled from the magazine 136 is monitored. Examples of monitoring the total length of film 138 include computing the total length based on a rotational angle of one or both of the driven feed rollers 156, based on a number of electrical pulses set to a stepper motor or based on a total number of counted perforations. When excessive withdrawal force is encountered as the film 138 is being pulled from the film magazine 136, the length of film 138 that has been withdrawn from the magazine 136 is compared to an expected length of film 138. One technique for determining the expected length of the film 138 involves calculating the expected length of the film 138 based at least partially on film attribute data (for example, the number of exposures) captured by the data acquisition capture device 146 at the film magazine loading station 134. Techniques for determining withdrawal force include using a force transducer to measure a force required to hold the magazine carriage 142 at a given position, using a displacement transducer for determining movement of the magazine carriage 142 and measuring a required electrical of a motor driving the feed rollers 156.

During the operation of pulling the film 138 from the film magazine 136, the feed rollers 156 continue to drive until a prescribed condition is met if the withdrawn length is within limits of the expected length when excessive withdrawal force is detected. Examples of the prescribed condition resulting in the film 138 being cut include the “paster tape” that anchors the tail end of the film 138 to the spindle of the film magazine 136 being detected by a sensing device, a prescribed current of a drive motor being exceeded or a surface of the film magazine 136 is detected by a suitable sensing device. When such prescribed condition is met, the tail end of the film 138 is cut by the second film cutting device 154, thus freeing the film 138 from the film magazine 136.

The feeding operation is stopped prior to the tail of the film 180 passing through the driven feed rollers 156. Accordingly, the tail of the film 138 is cut from the spindle of the film magazine 136; the film magazine 136 is deposited into a waste receptacle 208.

The film processing system 2 is capable of rejecting the film 138 and returning film 138 to the user or the film delivery system if the withdrawn length is not within the limits expected when excessive withdrawal force is detected. In one embodiment of a technique for rejecting and returning the film 138, the film 138 is rewound into the film magazine 136 by a suitable drive system (not shown) and then returned to the user, returned to the film delivery system or deposited in a storage bin. An example of a suitable drive system is one that is capable of driving the spindle of the film magazine 136.

Once the film 138 is fully wound into the film reverser 194, the film diverter 158 is moved to the bypass position for routing the film 138 from the film reversing station 192 to the splicing station. The film 138 is then fed from the film reverser 194 to the splicing station for being spliced to a threaded leader 210.

At a leader supply station 212, the threaded leader 210 is cut by a leading cutting device 214 prior to the leading end of the film 138 reaching the splicing station. In response to cutting the threaded leader 210 from a leader supply roll 214, a trailing end 216 of the threaded leader 210 is defined. The trailing end 216 of the threaded leader 210 is positioned at a splicing device 218 of the splicing station. A heated splicing head is an example of the splicing device 218. A supply of thermal splicing tape is provided to the splicing device 218.

When the leading end of the film 138 is positioned at the splicing device 218, the splicing device 218 is activated for facilitating splicing of the leading end of the film 138 to the trailing end 216 of the threaded leader 210. Examples of techniques for positioning of the leading end of the film 138 at the splicing station include using a sensor to sense the leading end and feeding the leading end of the film 138 a prescribed feed distance from the reversing station 192. The leader supply roll 214 and leader material attached thereto can need to be rewound partially, such as via leader feed rollers 222, for enabling the leading end of the film 138 to be positioned at the splicing device 218.

The use of the threaded leader 210 as disclosed herein advantageously permits the film processing system 2 to sequentially, but not necessarily continually process multiple rolls of film. The threaded leader 210 provides a simple yet effective means of threading the film 138 from the reversing station 192 through the remaining stations of the film processing system 2.

As depicted in FIG. 1, when the leading edge of the film 138 reaches the reversing station 192, a previously processed film 224 is a considerable distance ahead of the film 138 along the process path. For example, in the case of a self-service film processing system, such as a kiosk, film processed for a first customer will be completed before beginning the processing of film for a second customer. Implementation of the threaded leader 210 provides continuity along the process path between various rolls of film. The leader facilitates processing of an initial roll of film upon startup of the film processing system 2.

The film processing system 2 includes a cleaning station 226. One embodiment of the cleaning station 226 includes a first particle transfer roller positioned for being engaged by a first surface of the film 138 and a second particle transfer roller positioned for being engaged by a second surface of the film 138. The cleaning station 226 is preferably positioned between the splicing station and a calibration exposure station 228. The cleaning station 226 can be positioned after the calibration exposure station 228. A first portion of the cleaning station 226 (for example, the first particle transfer roller) may be positioned before the calibration exposure station 228 and a second portion of the cleaning station 226 (for example, the second particle transfer roller) may be after the calibration exposure station 228. Preferably, the particle transfer roller that is engaged by the side of the film 138 that receiving a calibration exposure is positioned before the calibration exposure station 228.

The calibration exposure station 228 facilitates the calibration exposure being made on an unexposed portion of the film 138. As discussed above, film 138 is reversed such that an unexposed portion of the film 138 is provided at the leading end of the film 138. Accordingly, information provided by the calibration exposure is capable of being determined prior to any of the frame exposures of the film 138 being digitally processed as disclosed herein.

Providing the calibration exposure at the leading end rather than the trailing end 196 of the film 138 advantageously permits images from the film 138 to be processed by a data processing system, such as the data processing system of the improved digital film processing system disclosed herein, in parallel with the film 138 being developed. For example, after a first frame exposure is developed, processing of an image associated with the first frame exposure is performed by the data processing system of the improved digital film processing system while a second frame exposure is developed by the film processing time for a roll of film and the time required for displaying a first image and each subsequent image for a roll of film.

A buffer station 230 provides a variable length of the film 138 and/or threaded leader 210 for allowing one portion of the film 138 to be maintained in a moving state while another portion of the film 138, the threaded leader 210 or both is at an idle state. For example, process operation associated with an applicator station 232, a development station 234 and a scanning station 236, intermittent operations are being performed on second portion of the film 138 and/or the threaded leader at the splicing station and at the calibration exposure station 228. These intermittent operations require the film 138 to be at an idle state for a period of time. The variable length of film 138 and/or threaded leader 210 provided by the buffer station 230 permits such continuous and intermittent process operations to co-exit in the film processing system 2.

At the applicator station 232, a processing solution is applied to the film 138. The development station 234 operates to give the film 138 sufficient time to develop prior to developed images being scanned at the scanning station 236. A web take-up station 237 includes a drive-reel for having processed film and attached leaders wound thereon.

The magazine loading station 134, the tongue extraction station 148, the reversing station 192, the splicing station, the leader supply station 212 and the web take-up station 237 comprise a transport system in accordance with one embodiment of the invention. Such a transport system is particularly suited for a developing system intended for use in a self-service film processing system. Specifically, the construction and utility of the magazine loading station 134, the tongue extraction station 148, the reversing station 192, the splicing station, the leader supply station 212 and the web take-up station 237 are well-suited for self-service film processing system. A transport system can also be useful in other types of film processing system besides a self-service film processing system.

In an embodied method for unloading film from a single-use camera or cartridge, a user selects whether a single-use camera or a single roll of film is placed into the embodied system or kiosk that contains the embodied device. If the user selects a single-use camera, the input wheel is rotated so the single-use camera cavity or receptacle is presented to the user. A graphical label of a single-use camera adhered to the cavity surface can show the user the proper orientation of insertion. The user places the camera into the cavity and closes a safety door. The input module senses the camera and begins to rotate the camera away from the user. As the rotation occurs, clamps seat the single-use camera. During the clamping action, a pin in conjunction with a gear and motor defeats the anti-backup pawl on the camera and a rib feature defeats the de-meter function. A pin flexes the anti-pawl on the camera, thereby reducing friction and noise during wind-up. After rotating the pivotable housing between 10 degrees and 90 degrees using motor, the input module stops and engages with a film wind-off mechanism. After a few seconds of wind off, the input module continues to rotate another 137 degrees or so and stops.

If the film wind off is unsuccessful, the camera is returned to the customer by rotating the pivotable housing in the opposite direction. The film access door-prying device is now engaged with the film wind off mechanism. The film door prying can be accomplished using a four-bar linkage or similar mechanism. The film wind off mechanism moves at a much slower rate and rotates the prying device linkage 95 degrees or so thereby opening the film access door.

If the film wind off is successful, the film magazine removal mechanism travels into the input module, wherein an extractor removes the film magazine out of the single-use camera. When the film magazine is safely out of the camera, the input module rotates back to the starting position. During the travel to the starting position, the clamping mechanism holding the camera opens using a second gear and a second motor, thereby releasing the camera. The single-use camera can now fall into a re-cycling container or other interface device.

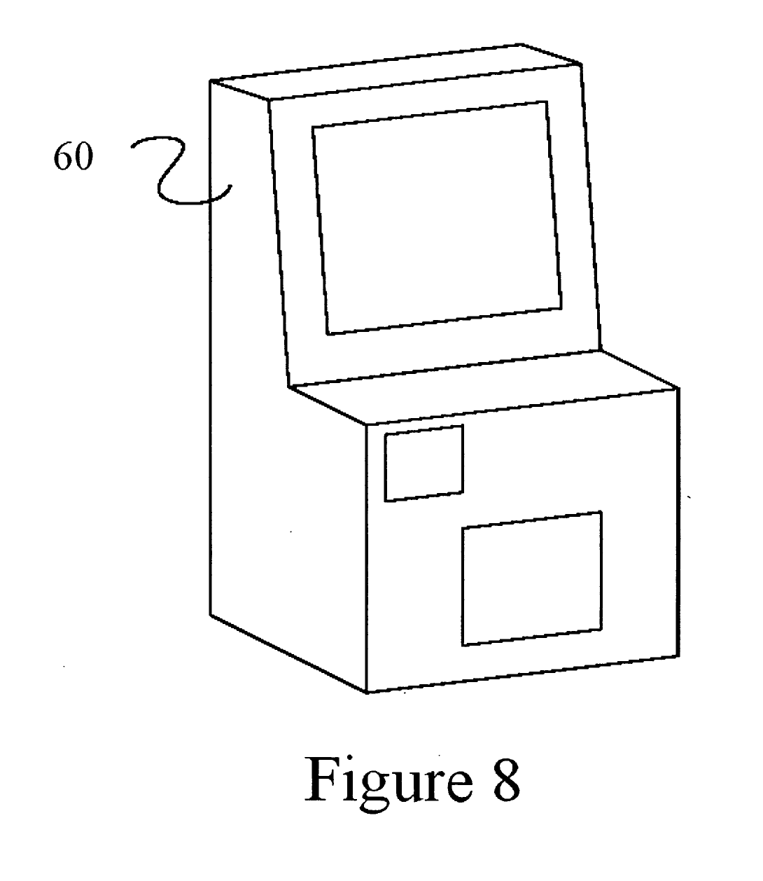

The digital film development system and embodied device are adapted to be contained in a self-service kiosk 60, such as the kiosk depicted in FIG. 8. The self-service film processing system is uniquely suited to new locations because the system uses less space than other kiosks. As a result, a self-service film processing system can be located in hotels, airports, or other suitable locations that are convenient for users, but have high rental costs on a square foot basis.

The embodiments have been described in detail with particular reference to certain preferred embodiments thereof, but it will be understood that variations and modifications can be effected within the scope of the embodiments, especially to those skilled in the art.

### PARTS LIST

2. film processing system
4. enclosure
10. housing
11. cavity
12. camera
13. light from lens
14. take-up cartridge
15. lens
16. metering mechanism
17. clamp
18. clamp
21. actuator
22. first motor
28. gear
30. second motor
34. second gear
36. hook mechanism
37. hook
38. cartridge extractor
40. transfer device
42. frame
44. rib
46. roller
50. cam feature
60. kiosk
134. film magazine loading station
136. film magazine
138. film
142. magazine carriage
146. data acquisition device
148. tongue preparation station
150. tongue extraction device
152. first film cutting device
154. second film cutting device
156. driven feed rollers
158. film diverter
164. tongue stripper
166. light-tight film window
167. spindle
168 tongue stripper leading end
170. tongue extractor leading end
171. tongue extractor
172. film tongue
174. tongue stripper outside face
176. film magazine interior surface
178. tongue extraction method
180. friction pad
190. film inspection station
192. film reversing station
194. film reverser
198. film reverser spindle
200. cavity
208. waste receptacle
210. threaded leader
212. leader supply station
214. leading cutting device
216. threaded leader trailing end
218. splicing device
222. leader feed rollers
224. previously processed film
226. cleaning station
228. calibration exposure station
230. buffer station
232. applicator station
234. development station
236. scanning station
237. web take-up station

1. A device for unloading a single-use camera, wherein the device:
a. a pivotable housing with a cavity, wherein the cavity is adapted to receive a single-use camera comprising a film supply chamber, a film, a take-up cartridge, a lens, a shutter, and a metering mechanism;
b. a first clamp and a second clamp, wherein the first clamp comprises a de-metering protrusion adapted to deactivate the metering mechanism in the single-use camera;
c. an actuator adapted to affect the first and second clamps to engage and release the single-use camera;
d. a first motor adapted to pivot the pivotable housing from a first position to a second position;
e. a first gear connected to a second motor, wherein the first gear is adapted to wind film from the single-use camera into the take-up cartridge;
f. a hook mechanism with a hook driven by a second gear and the second motor, wherein the hook mechanism is adapted to open the single-use camera;
g. a cartridge extractor adapted to remove the take-up cartridge with rewound film from the single-use camera; and
h. a transfer device adapted to move the take-up cartridge with film from the single-use camera to an operator selected position.

2. The device of claim 1, wherein the pivotable housing is polymer, plastic, metal, coated metal, or combinations thereof.

3. The device of claim 1, wherein the pivotable housing comprises a centrally located pivot.

4. The device of claim 1, wherein the pivotable housing is adapted to rotate up to 360 degrees.

5. The device of claim 1, wherein the pivotable housing pivots from the first position to the second position a distance ranging from about 10 degrees to about 90 degrees.

6. The device of claim 5, wherein the distance from the first position to the second position is 43 degrees.

7. The device of claim 1, wherein the metering mechanism comprises a locking thumbwheel adapted to advance the film.

8. The device of claim 7, wherein the metering mechanism further comprises a counter.

9. The device of claim 1, wherein the metering mechanism prevents film advancement between successive images.

10. The device of claim 1, wherein the pivotable housing rotates around a frame, and wherein the actuator further comprises a plurality of rollers adapted to engage a rib disposed on the frame and to open and close the clamps.

11. The device of claim 1, wherein the gears are spur gears.

12. The device of claim 1, wherein the first and second motors are stepper motors.

13. The device of claim 1, wherein the hook further comprises a cam feature adapted to push and open the single-use camera.

14. A method for unloading film from a single-use camera, wherein the method comprises the steps of:
a. dropping a single-use camera with a film into a cavity disposed in a housing;
b. clamping onto the single-use camera using a clamp;
c. de-metering the film;
d. winding film into a take-up cartridge in the single-use camera using a first gear;
e. rotating the housing between 10 degrees and 90 degrees with a first motor;
f. opening the camera using a second gear and a second motor;
g. extracting the film with the take-up cartridge from the housing using an extractor while rotating the housing;
h. opening the clamp to release the single-use camera; and
i. dropping the single-use camera into a recycle bin.

15. The method of claim 1, wherein the camera comprises the film that is selected from the group consisting of partially used film, totally used film, or never used film.
